(19) United States
(12) Patent Application Publication
(10) Pub. No.: US 2026/0040039 A1
(43) Pub. Date: Feb. 5, 2026

(54) OVER-THE-AIR OCCUPANCY GRID AGGREGATION USING COMPRESSED SENSING

(71) Applicant: QUALCOMM Incorporated, San Diego, CA (US)

(72) Inventors: Stelios STEFANATOS, San Diego, CA (US); Kapil GULATI, Belle Mead, NJ (US); Mahmoud ASHOUR, San Diego, CA (US); Shuanshuan WU, San Diego, CA (US); Sony AKKARAKARAN, Poway, CA (US); Arthur GUBESKYS, San Diego, CA (US)

(21) Appl. No.: 19/100,536

(22) PCT Filed: Sep. 15, 2023
(86) PCT No.: PCT/US2023/074356

§ 371 Date: Jan. 31, 2025

(30) Foreign Application Priority Data
Sep. 23, 2022 (GR) 20220100782

(51) Int. Cl. H04W 4/38; G01C 21/00; H04L 69/04

(52) U.S. Cl. CPC H04W 4/38; G01C 21/00; H04L 69/04

(57) ABSTRACT

Aspects of the present disclosure include methods, apparatuses, and computer-readable medium for generating an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors; applying a sensing matrix to the occupancy vector to generate a compressed occupancy vector that has fewer elements than the occupancy vector; and transmitting, to a network entity, one or more signals indicative of the compressed occupancy vector.

### CROSS-REFERENCE TO RELATED APPLICATIONS

This application claims the benefit of Greece patent application Ser. No. 20/220,100782, entitled OVER-THE-AIR OCCUPANCY GRID AGGREGATION USING COMPRESSED SENSING, and filed on Sep. 23, 2022, which is expressly incorporated by reference herein in its entirety.

### BACKGROUND

The present disclosure relates generally to wireless communication systems, and more particularly, to techniques for occupancy grid aggregation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communication by a user equipment (UE). The method includes generating an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors. The method further includes applying a sensing matrix to the occupancy vector to generate a compressed occupancy vector that has fewer elements than the occupancy vector. The method further includes transmitting, to a network entity, one or more signals indicative of the compressed occupancy vector.

Another example aspect includes a user equipment (UE) comprising a memory storing instructions; and at least one processor coupled with the memory. The at least one processor is configured to execute the instructions to generate an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors. The at least one processor is further configured to execute the instructions to apply a sensing matrix to the occupancy vector to generate a compressed occupancy vector that has fewer elements than the occupancy vector. The at least one processor is further configured to execute the instructions to transmit, to a network entity, one or more signals indicative of the compressed occupancy vector.

Another example aspect includes a method of wireless communication by a network entity. The method includes receiving one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell. The method further includes recovering an aggregated occupancy vector of the area from the one or more aggregated signals based on the sensing matrix, wherein the aggregated occupancy vector represents an aggregation of one or more occupancy vectors that represent the occupancy grid as observed by the one or more UEs.

Another example aspect includes a network entity comprising a memory storing instructions; and at least one processor coupled with the memory. The at least one processor is configured to execute the instructions to receive one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell. The at least one processor is further configured to execute the instructions to recover an aggregated occupancy vector of the area from the one or more aggregated signals based on the sensing matrix, wherein the aggregated occupancy vector represents an aggregation of one or more occupancy vectors that represent the occupancy grid as observed by the one or more UEs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, including user equipment (UE) and base station components for implementing occupancy grid aggregation, according to some aspects of the present disclosure.

FIG. 2A is a diagram illustrating an example of a first 5G/NR frame for use in communication by the base stations and/or the UEs in FIG. 1, according to some aspects of the present disclosure.

FIG. 2B is a diagram illustrating an example of DL channels within a 5G/NR subframe for use in communication by the base stations and/or the UEs in FIG. 1, according to some aspects of the present disclosure.

FIG. 2C is a diagram illustrating an example of a second 5G/NR frame for use in communication by the base stations and/or the UEs in FIG. 1, according to some aspects of the present disclosure.

FIG. 2D is a diagram illustrating an example of UL channels within a 5G/NR subframe for use in communication by the base stations and/or the UEs in FIG. 1, according to some aspects of the present disclosure.

FIG. 3A is a diagram illustrating an example system including UEs that detect one or more occupied cells in an occupancy grid associated with an area, according to some aspects of the present disclosure.

FIG. 3B is a diagram illustrating an aggregated occupancy grid of the area in the example system of FIG. 3A, according to some aspects of the present disclosure.

FIG. 4 is a diagram illustrating an example of using compressed sensing for reporting a compressed vector representing an occupancy grid as observed by a UE, according to some aspects of the present disclosure.

FIG. 5 is a diagram illustrating an example of a base station and a UE in an access network, according to some aspects of the present disclosure.

FIG. 6 is a diagram illustrating an example of disaggregated base station architecture, according to some aspects of the present disclosure.

FIG. 7 is a block diagram of an example UE configured for implementing occupancy grid aggregation functionality, according to some aspects of the present disclosure.

FIG. 8 is a flowchart of an example method of wireless communication by a UE for implementing occupancy grid aggregation functionality, according to some aspects of the present disclosure.

FIG. 9 is a block diagram of an example network entity configured for implementing occupancy grid aggregation functionality, according to some aspects of the present disclosure.

FIG. 10 is a flowchart of an example method of wireless communication by a network entity for implementing occupancy grid aggregation functionality, according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Aspects of the present disclosure provide a user equipment (UE) that generates a compressed occupancy vector by applying a sensing matrix to an occupancy vector of an area of interest as observed by the UE using one or more UE sensors (e.g., camera, radar, lidar). An occupancy grid is a grid that divides an area of interest into a number of cells, where each cell is characterized by a state that indicates whether that cell is occupied by an object. Associated with an occupancy grid is a corresponding “occupancy vector” whose number of elements equals the number of cells in the occupancy grid. Each element of the occupancy vector is associated with a unique cell in the occupancy grid, and the value of the element reflects the state of the corresponding cell (occupied or not occupied). The terms occupancy grid and occupancy vector may be used interchangeably throughout the present disclosure.

Each cell of an occupancy vector as observed by a UE has a value indicating whether the UE has detected an associated cell as being occupied by an object such as another UE.

Compressed sensing refers to signal processing techniques that allow for compression of a sparse signal into a compressed signal (e.g., a signal of smaller number of elements than the original sparse signal) in such a way that the sparse signal is recoverable from the compressed signal. For example, a “sensing matrix” may be defined/configured such that a compressed vector may be obtained by applying the sensing matrix to a sparse vector.

After a UE generates a compressed occupancy vector, the UE may transmit each element of the compressed occupancy vector using a reserved/pre-configured resource element (RE) that has been pre-configured in common for multiple UEs for transmission of that element. The sensing matrix is also configured in common for the UEs, so that each of the UEs may use the sensing matrix to generate a compressed occupancy vector of the area of interest and transmit each element of the compressed occupancy vectors using a respective commonly-configured RE. Accordingly, a network entity may receive an over-the-air aggregation of the compressed occupancy vectors of the UEs over the pre-configured REs, and recover an aggregated occupancy vector of the area of interest based on knowledge of the sensing matrix.

Further details of the present aspects are described below with reference to the appended drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

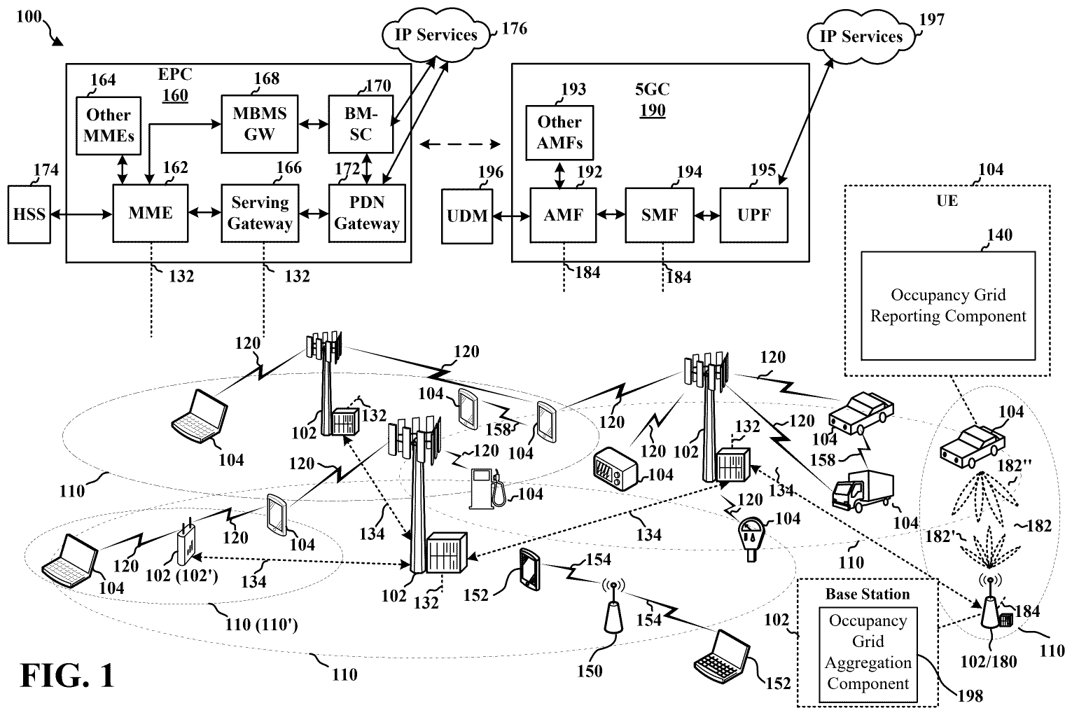

FIG. 1 is a diagram illustrating an example of a wireless communications system and an access network 100 including UEs 104 and a network entity 102, also referred to herein as a base station 102 (e.g., a gNB) and/or a disaggregated base station, configured to implement occupancy grid aggregation functionality. In an aspect, for example, a UE 104 may include an occupancy grid reporting component 140 configured to generate a compressed occupancy vector by applying a sensing matrix to an occupancy vector of an area of interest as observed by the UE 104 using one or more UE sensors (e.g., camera, radar, lidar). Each element of the occupancy vector as observed by the UE 104 has a value indicating whether the UE 104 has detected an associated cell of an occupancy grid as being occupied by an object such as another UE 104. The UE 104 may transmit each element of the compressed occupancy vector using a reserved/pre-configured resource element (RE) that has been pre-configured in common for multiple UEs 104 for transmitting that element. The sensing matrix is also configured in common for the UEs 104, so that each of the UEs 104 may use the sensing matrix to generate a compressed occupancy vector of the area of interest and transmit each element of the compressed occupancy vector using a respective commonly-configured RE. Accordingly, an occupancy grid aggregation component 198 in the network entity 102 may receive an over-the-air aggregation of the compressed occupancy vectors of the UEs 104 over the common pre-configured REs, and recover an aggregated occupancy vector of the area of interest based on knowledge of the sensing matrix.

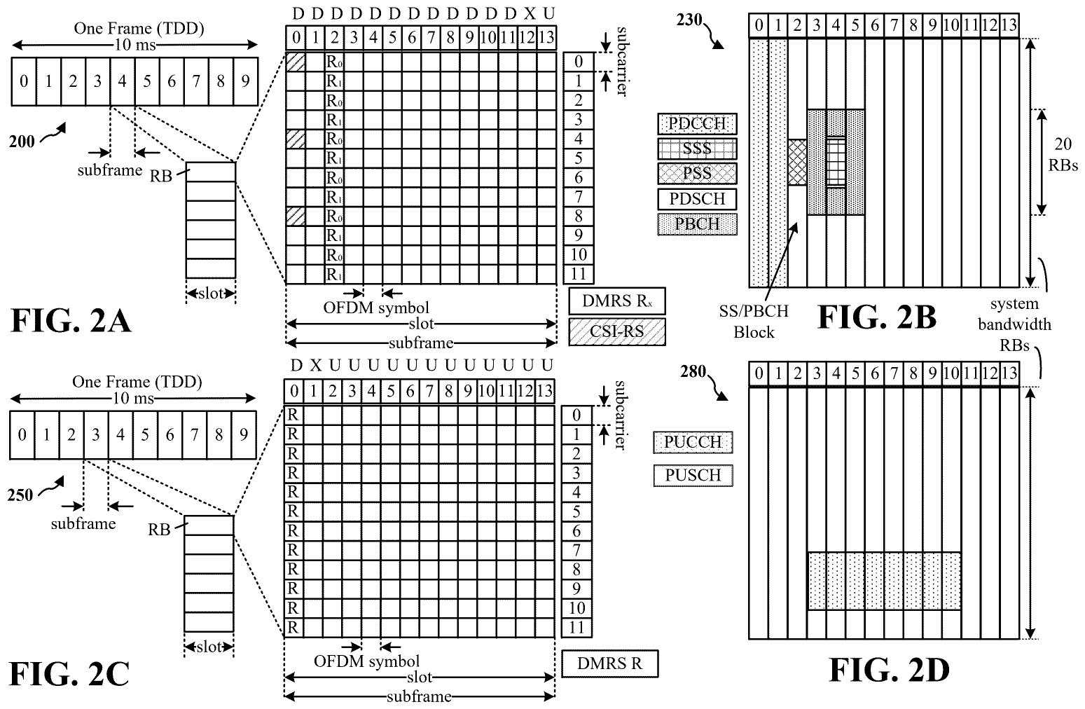

Further details of the operation of the occupancy grid reporting component 140 of the UE 104 and the occupancy grid aggregation component 198 of the network entity 102 are described below with reference to FIGS. 2A-2D, 3A, 3B, and 4-10.

The wireless communications system (also referred to as a wireless wide area network (WWAN)) may also include other base stations 102, other UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158, e.g., including synchronization signals. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring to FIGS. 2A-2D, one or more example frame structures, channels, and resources may be used for communication between the base stations 102 and the UEs 104 of FIG. 1. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

An occupancy grid refers to a grid that divides an area of interest into a number of cells, where each cell is characterized by a state indicating whether or not that cell is occupied by an object. Associated with an occupancy grid is a corresponding “occupancy vector” whose number of elements equals the number of cells in the occupancy grid. Each element of the occupancy vector is associated with a unique cell in the occupancy grid, and the value of the element reflects the state of the associated cell (occupied or not occupied). An occupancy vector as observed by a UE (which may be a vehicle, a device associated with/carried by a pedestrian, a device configured on or in a building, etc.) may combine information obtained from different sensor types of the UE (e.g., camera, radar, lidar, etc.) to indicate whether each cell of an associated occupancy grid is occupied by an object, where the object may be a vehicle, a guard rail on the side of a road, buildings along a road, etc. Accordingly, the occupancy vector may provide an improved understanding of an environment where a UE is located.

An occupancy vector as observed by one UE is limited by the range and/or angular field-of-view of the sensors of that UE and/or by occlusion of a field-of-view of that UE by other vehicles/objects. However, applications such as advanced driver assistance systems (ADAS) may require an understanding of the environment that is not limited by such sensor capabilities and occlusions.

Some systems implement a cooperative operation where multiple UEs share their locally-computed occupancy vector of a certain common area of interest so that an aggregated/fused occupancy grid may be generated. In this case, the aggregated occupancy grid provides more information than what a single UE may individually achieve. However, when multiple UEs contribute to the occupancy grid aggregation, the number of (dedicated) resources used for communication of occupancy vector information by the UEs may become excessive, in particular in cases where a dynamic occupancy grid is required to identify objects such as mobile objects, hence requiring frequent updates.

Some systems allow for over-the-air (OTA) aggregation of UE occupancy vectors, where for each cell of an occupancy grid, a resource element (RE) is configured in common for multiple UEs to transmit their respective information of that cell over the associated RE to be OTA-aggregated. These systems provide a scalable approach that renders the required resources independent of the number of UEs, but equal to the number of cells in the occupancy grid. However, for occupancy grids of high resolution (e.g., consisting of a very large number of small cells), the resources required by this approach may still be high. Accordingly, some present aspects improve the efficiency of the OTA occupancy grid aggregation by exploiting the sparsity of the occupancy grid to generate compressed occupancy information using compressed sensing. In some cases, the present aspects may reduce the required resources by an order of magnitude (depending on the sparsity of the grid). Further details of the present aspects are provided below.

In some systems, environment information (“maps”) is required for automotive applications. For applications such as ADAS and (self-)positioning, high-definition (HD) maps are required, e.g., maps that have more detail than conventional maps. One way for a UE to generate HD map information is to utilize the sensors of that UE, such as radar, lidar, and cameras, and fuse their observations (sensing), towards generating a map in real-time. One option towards a low-level data fusion from diverse types of sensors is the occupancy grid. In this approach, a geographical area is discretized (quantized) into cells, and each cell is identified as “occupied” if any of the UE sensors has identified the presence of an object over that cell. An object may potentially occupy multiple (adjacent) cells, depending on the object size and the grid resolution (cell size). Accordingly, the occupancy grid is a “point cloud” map (e.g., similar to what is used in radar systems) where the points in the point cloud are aligned with the (pre-configured) grid cells and the occupancy of a cell is determined by fusing one or more sensing information a UE has (e.g., the output of multiple sensors of the UE, e.g., radar, lidar, cameras, etc.).

Although the occupancy grid enhances the information/understanding about the area the UE is in (in addition to the information provided by conventional maps), the occupancy grid is limited by the limitations of the UE sensors, such as range, angular field-of-view, etc. For example, if a UE is equipped with a single sensor (e.g., a radar mounted on the front grill of a vehicle) that has a field-of-view spanning +20 degrees with respect to the boresight and can detect up to 150 meters distance, the resulting occupancy grid (point cloud) has the same limitations as the sensor in terms of area coverage. Another issue that may impact the occupancy grid negatively is “visibility gaps” that sensor(s) may experience due to occlusions that a UE is subject to. For example, in an urban intersection, a “target” (e.g., a vehicle or pedestrian) may not be visible to a sensor of a UE even if the target is located within the sensor coverage of the UE sensors, due to occlusions by, for example, one or more vehicles and/or buildings.

Some systems overcome these issues by fusing the occupancy grids computed by each UE in an area to generate an “aggregated” (or global) occupancy grid. In this case, multiple UEs cooperate by creating a network of distributed sensors whose observations over a given area of interest are combined. A central server (such as a network entity) gathers the occupancy grid information of each UE, aggregates the grids, and potentially broadcasts the aggregated grid back to the UEs.

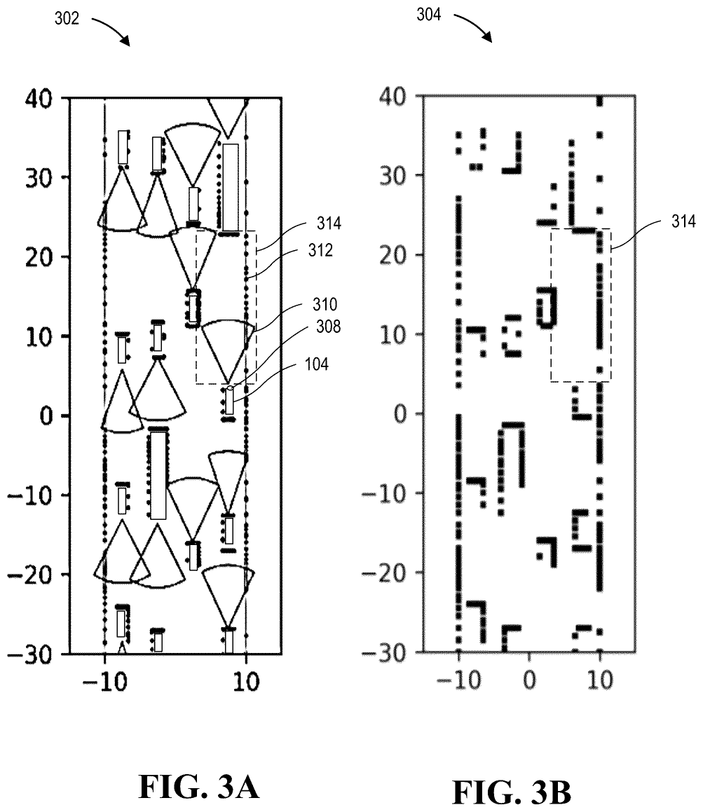

Referring to FIG. 3A, in one example non-limiting aspect, an area 302 (for example, a 70 meter by 20 meter area in a 4-lane highway/freeway) may include UEs 104 that each are equipped with at least one sensor 308 (such as, but not limited to, a radar mounted on a front grill of a vehicle). A point cloud 314 may be generated by each UE 104, where the point cloud 314 includes one or more points 312 that are detected by the sensor 308 of that UE 104. The point could 314 generated by each UE 104 is limited by a range/field-of-view 310 of the sensor 308 of that UE 104. However, an aggregated occupancy grid 304 (FIG. 3B) may be generated for the area 302 by aggregating the individual point clouds of multiple cooperating UEs in the area 302. For example, in an aspect, the aggregated occupancy grid 304 may be obtained by first translating the local radar point cloud of each UE to a local occupancy grid and then aggregating them. The aggregated occupancy grid 304 provides more information than what a single sensor may achieve. This is due to the limited field-of-view and/or range of that sensor and/or due to occlusions by vehicles, buildings, etc.

For applications such as ADAS, map information requires continuous updating to be able to track both long-term and short-term variations/changes of the environment. Accordingly, a “dynamic” occupancy grid needs to be obtained and maintained. Such a dynamic aggregated cooperative occupancy grid requires the contributing UEs to sense and transmit their grid at about the same time, with this procedure repeated with a frequency proportional to the dynamics of the environment. However, having every UE provide a respective occupancy grid over dedicated resources at the same time results in large communication overhead that is proportional to the number of contributing UEs. This may not be a scalable approach.

Some systems provide an efficient and scalable procedure toward generating cooperative dynamic occupancy grids from a number of UEs with potentially high update rates. For example, in some systems, each grid cell of an area is mapped to a unique resource element (RE) that is common to all contributing UEs. If a UE observes a cell as occupied, that UE transmits a +1 (or some other pre-configured positive value) over the corresponding RE. A server (e.g., a network entity) may then measure the received energy over the RE. If the received energy exceeds a thresholds, the network entity deduces that at least one UE has identified the corresponding cell as occupied.

In some present aspects, the aforementioned OTA aggregation is made more efficient in terms of resource utilization by using compressed sensing.

In compressed sensing, a sparse vector is compressed into a compressed vector with fewer elements, in such a way that the sparse vector is recoverable from the compressed vector. For example, assuming x∈R^{N} denotes an unknown vector consisting of N real-valued elements, and A denotes a (possibly, complex valued) known matrix (referred to herein as “sensing matrix”) of dimensions m×N (rows x columns), and y=Ax denotes the observation of x after application of the sensing matrix, the last equation is a linear system that can be solved with respect to unknown x. A unique solution (e.g., in a least squares sense) requires m≥N (at least as many equations as unknown elements). However, compressed sensing is an approach that allows retrieving x from y and A even when m<<N. This requires the additional assumption that the unknown vector x is sparse, that is, the number of non-zero elements of x is much smaller than the size N of x. Under this assumption, various algorithms (such as, for example, Orthogonal Matching Pursuit (OMP)) may be used to retrieve x (also in the presence of noise) without explicitly knowing the number of non-zero elements of x (as long as m is greater than this number). How small can m get and still allow recovery of x depends on the considered sensing matrix A.

In some non-limiting aspects, for example, the sensing matrix A may be selected to minimize m.

In some non-limiting aspects, for example, the sensing matrix A may be selected as a random matrix with independent and identically distributed (i.i.d.) normal (Gaussian) elements.

In some non-limiting aspects, for example, the sensing matrix A may be generated by randomly discarding rows of square (N×N) discrete Fourier transform (DFT) matrices.

In some aspects, the number of occupied cells in an area of interest may be much smaller than the total number of cells in the area (especially if a high resolution grid is considered). For example, if an area is partitioned into N cells and x∈R^{N} represents the occupancy grid of that area with elements either 0 or 1, corresponding, respectively, to unoccupied or occupied cells, the number of elements equal to 1, m, is much smaller than the total number of cells, N.

Referring to FIG. 3B, for example, the number of cells in the aggregated occupancy grid 304 is N=8400 and the number of occupied cells m is less than 200. This means that under OTA aggregation of the occupancy grid, with N REs dedicated to indicate the occupancy of the N grid cells, out of the N observed REs, only a (very) small number m of REs will actually correspond to a non-zero transmission. Therefore, some present aspects use compressed sensing for OTA occupancy grid aggregation, where the number of REs reserved for OTA aggregation is m (typically, much smaller than the number of grid cells, N).

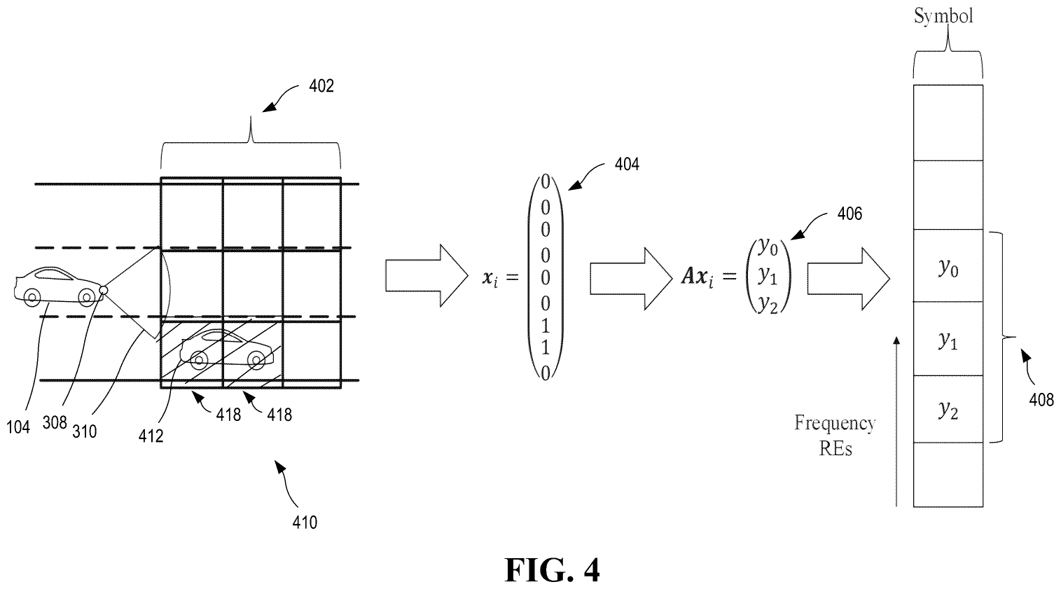

Referring to FIG. 4, in some non-limiting aspects, for example, an i^{th} UE 104 (e.g., a vehicle) computes an occupancy grid 402 (e.g., with N=9 cells in FIG. 4) of an area 410 based on a sensing (310) of the i^{th} UE 104 (e.g., based on an output of a sensor 308, such as a radar, camera, lidar, etc., of the i^{th} UE 104). The i^{th} UE 104 generates an occupancy vector 404, xᵢ, where xᵢ∈R^{N} and includes N elements of 0s and 1s (an element of 1 indicating the corresponding cell is an occupied cell 418 that is occupied by an object 412 (e.g., occupied by another vehicle)). The i^{th} UE 104 then applies a linear transformation to xᵢ based on a common (to all UEs) sensing matrix A of dimension m×N (e.g., m×N=3×9 in FIG. 4), resulting in an m-dimensional compressed occupancy vector 406, yᵢ (e.g., m=3 in FIG. 4). For each of the m elements of yᵢ, there corresponds a unique RE out of m pre-configured/reserved REs 408, where an RE may be, but is not limited to, a frequency RE in a symbol. This mapping of the m elements to the m REs is in common for multiple UEs that each generate a respective compressed occupancy vector of the area 410. The i^{th} UE 104 then transmits the (analog) complex value of the m-th element of yᵢ over the corresponding RE.

In some aspects, the N-dimensional occupancy vector 404 of the i^{th} UE 104, xᵢ, includes mostly zero-valued elements except the ones corresponding to occupied cells 418 that have the value of +1. An OTA-aggregated occupancy vector (out of multiple UEs) may be represented as x=Σᵢxᵢ, with addition performed in the domain of real numbers (no binary addition). x also includes mostly zero elements, expect for those elements where at least one UE identified the corresponding cell as occupied. The value of the non-zero elements equals the number of UEs that observed the corresponding cell as occupied. If each UE transmits its own xᵢ using N REs (which are configured in common for multiple UEs), the server (e.g., a network entity) effectively observes over these REs the value Σᵢxᵢ, which is what is needed to determine the aggregated occupancy grid (no need to know the individual xᵢ's). In the present aspects, however, the server (e.g., a network entity) observes, over m REs, the values ΣᵢAxᵢ=AΣᵢxᵢ.

Although Σᵢxᵢ is not directly observed, it can be retrieved from AΣᵢxᵢ by leveraging the fact that Σᵢxᵢ is sparse and by using compressed sensing techniques. Accordingly, significant saving of resources (m REs instead of N REs) is achieved, while retaining the scalability property of OTA aggregation with respect to the quantity of UEs.

In some aspects, the sensing matrix A, which is configured in common for multiple UEs, is configured to result in the smallest possible number of required REs (smallest m) while still ensuring recovery of the sparse aggregated occupancy vector Σᵢxᵢ.

In some aspects, for example, the sensing matrix A is pre-configured. For example, a lookup table of multiple A matrices with different combinations of values of m and N may be defined, and the UEs may use the (unique) A whose dimension matches the current configuration of m (the number of REs) and N (the number of cells).

Alternatively, a method (e.g., a formula) for generating the sensing matrix A may be used. For example, given m and N, a UE may generate the sensing matrix A by selecting m rows of the N×N DFT matrix, and the m row indices to be selected may be given by a formula, e.g., every 4^{th} row is selected when m=N/4.

Alternatively, the sensing matrix A may be indicated by a network entity via a pointer to a lookup table entry via RRC messaging and/or as part of DCI (the latter may be used to initiate a new OTA aggregation phase).

In some aspects, in deciding on the value of m (and, in turn, the sensing matrix A), a network entity may need to have a sense of how sparse the aggregated occupancy grid is. Accordingly, in some non-limiting example aspects, the UEs that sense (part of) the area of interest and participate in the OTA aggregation may indicate the number (or percentage) of cells they observe as occupied. This provides the network entity with a sense of how sparse the aggregated occupancy grid is based on the number of UEs contributing and how sparse each of the UEs senses the occupancy grid to be.

For example, in an aspect, if the occupancy grid includes 10000 cells, and if 50 UEs are each reporting less than 20 cells as occupied, the aggregated occupancy grid has less than 1000 cells occupied (possibly much less as the UE sensing areas may overlap).

In some aspects, for example, the UEs may transmit the above message periodically (e.g., with a pre-configured periodicity) and/or after explicit request by the network entity.

Some present aspects are robust to phase uncertainties as long as the phase error experienced by each UE is the same for all REs, which is a reasonable assumption. Under this assumption, the network entity may retrieve Σᵢe^{jϕ}^{ᵢ}xᵢ (instead of Σᵢxᵢ), where ϕᵢ∈[0,2π) is the (arbitrary) phase rotation that the i^{th} UE experiences. As long as the phases of UEs indicating the same cell as occupied do not add destructively, the corresponding element of Σᵢe^{jϕ}xᵢ is non-zero, hence the corresponding cell is identified as occupied by the network entity (which is the same as if the network entity had received Σᵢxᵢ under perfect phase synchronization).

However, there is a probability that the phases add destructively, which may render some cells that were identified as occupied by UEs to be declared as non-occupied by the network entity.

In order to reduce the probability of this destructive phase addition, in some present aspects, instead of one set of m REs, multiple set of m REs are used (e.g., 2 or 4) over which the m-dimensional compressed occupancy vector y; computed by the i^{th} UE is repeatedly transmitted over. If these sets of REs experience different (and advantageously independent) phases, the probability that at least one of these sets does not result in destructive addition is greater compared to only using one set of m REs. In some aspects, when the network entity receives multiple version of the same element of the aggregated compressed occupancy vector, the network entity only considers the version with the highest energy, because for the corresponding set of REs of that version, the phases did not add destructively (not to the extent of the other sets of REs).

In some aspects, a UE may apply an independent artificial phase to the elements of each copy of the compressed occupancy vector that the UE is about to transmit over the set of REs. For example, in an aspect, when OTA aggregation is performed using two sets of m REs, i^{th} UE computes the compressed occupancy vector yᵢ and transmits e^{jϕ}^{_{i,1}}yᵢ and e^{jϕ}^{_{i,2}}yᵢ over the two sets, respectively, where ϕ_{i,1}, ϕ_{i,2} are random artificially introduced phases. This may allow for each set of REs to experience intendent phases, which improves the chances of at least one set not adding destructively.

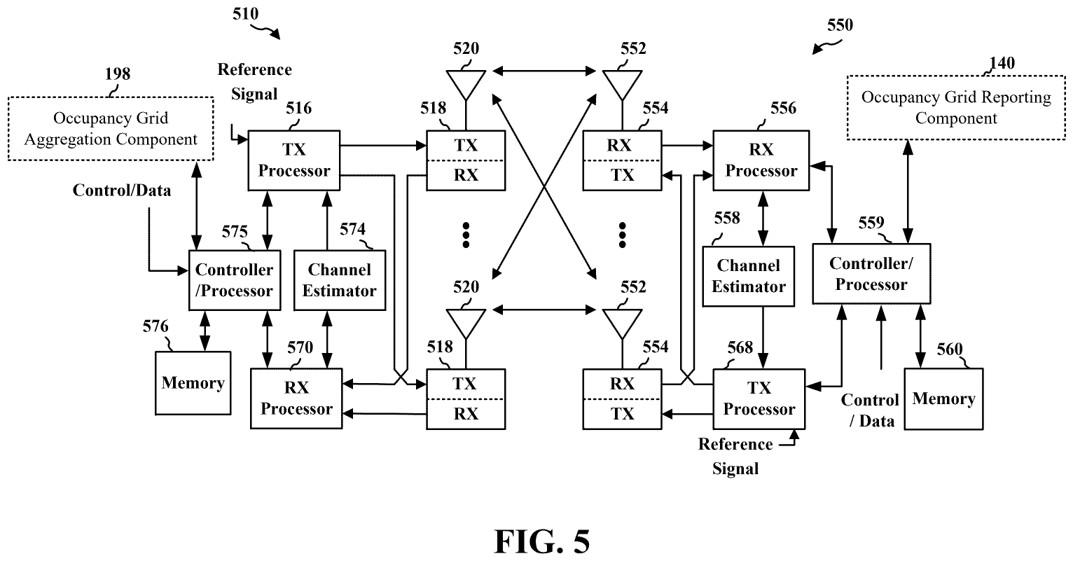

FIG. 5 is a block diagram of a base station 510 including occupancy grid aggregation component 198 in communication with a UE 550 including occupancy grid reporting component 140 in an access network, where the base station 510 may be an example implementation of base station 102 and where UE 550 may be an example implementation of UE 104. In the DL, IP packets from the EPC 160 may be provided to a controller/processor 575. The controller/processor 575 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 575 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 516 and the receive (RX) processor 570 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 516 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 574 may be used to determine the coding and modulation scheme, as well as for spatial processing. The channel estimate may be derived from a reference signal and/or channel condition feedback transmitted by the UE 550. Each spatial stream may then be provided to a different antenna 520 via a separate transmitter 518TX. Each transmitter 518TX may modulate an RF carrier with a respective spatial stream for transmission.

At the UE 550, each receiver 554RX receives a signal through its respective antenna 552. Each receiver 554RX recovers information modulated onto an RF carrier and provides the information to the receive (RX) processor 556. The TX processor 568 and the RX processor 556 implement layer 1 functionality associated with various signal processing functions. The RX processor 556 may perform spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 510. These soft decisions may be based on channel estimates computed by the channel estimator 558. The soft decisions are then decoded and deinterleaved to recover the data and control signals that were originally transmitted by the base station 510 on the physical channel. The data and control signals are then provided to the controller/processor 559, which implements layer 3 and layer 2 functionality.

The controller/processor 559 can be associated with a memory 560 that stores program codes and data. The memory 560 may be referred to as a computer-readable medium. In the UL, the controller/processor 559 provides demultiplexing between transport and logical channels, packet reassembly, deciphering, header decompression, and control signal processing to recover IP packets from the EPC 160. The controller/processor 559 is also responsible for error detection using an ACK and/or NACK protocol to support HARQ operations.

Similar to the functionality described in connection with the DL transmission by the base station 510, the controller/processor 559 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 558 from a reference signal or feedback transmitted by the base station 510 may be used by the TX processor 568 to select the appropriate coding and modulation schemes, and to facilitate spatial processing. The spatial streams generated by the TX processor 568 may be provided to different antenna 552 via separate transmitters 554TX. Each transmitter 554TX may modulate an RF carrier with a respective spatial stream for transmission.

The UL transmission is processed at the base station 510 in a manner similar to that described in connection with the receiver function at the UE 550. Each receiver 518RX receives a signal through its respective antenna 520. Each receiver 518RX recovers information modulated onto an RF carrier and provides the information to a RX processor 570.

The controller/processor 575 can be associated with a memory 576 that stores program codes and data. The memory 576 may be referred to as a computer-readable medium. In the UL, the controller/processor 575 provides demultiplexing between transport and logical channels, packet reassembly, deciphering, header decompression, control signal processing to recover IP packets from the UE 550. IP packets from the controller/processor 575 may be provided to the EPC 160. The controller/processor 575 is also responsible for error detection using an ACK and/or NACK protocol to support HARQ operations.

At least one of the TX processor 568, the RX processor 556, and the controller/processor 559 may be configured to perform aspects described herein in connection with occupancy grid reporting component 140 in the UE 104 of FIG. 1.

At least one of the TX processor 516, the RX processor 570, and the controller/processor 575 may be configured to perform aspects described herein in connection with occupancy grid aggregation component 198 in the network entity 102 of FIG. 1.

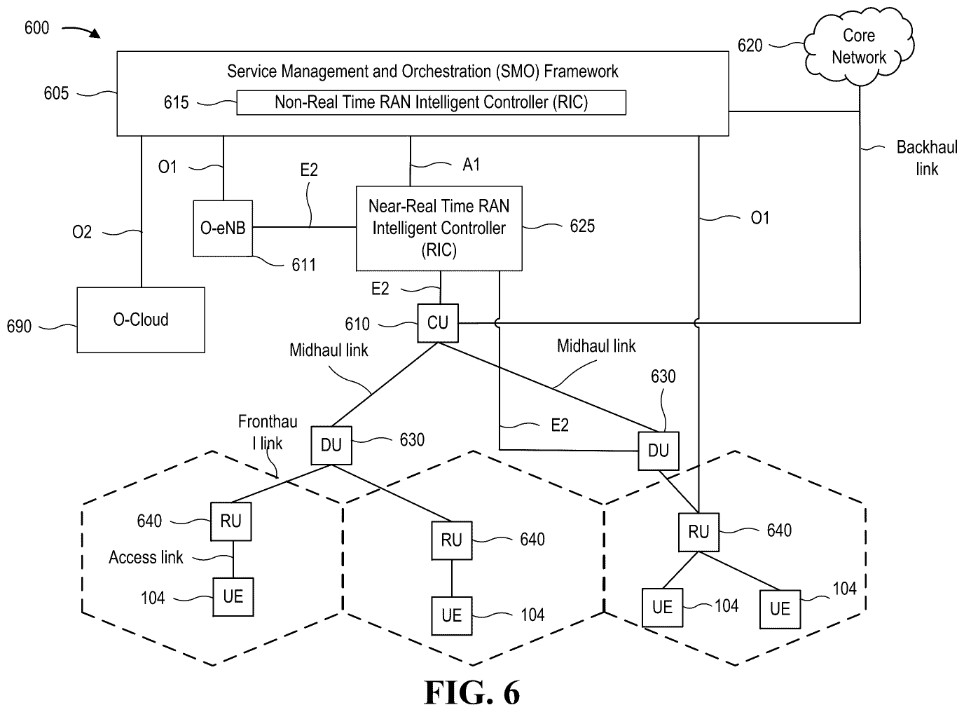

Referring to FIG. 6, an example of disaggregated base station 600 architecture includes one or more components that may act as a network device as described herein. The disaggregated base station 600 architecture may include one or more central units (CUs) 610 that can communicate directly with a core network 620 via a backhaul link, or indirectly with the core network 620 through one or more disaggregated base station units (such as a Near-Real Time (Near-RT) RAN Intelligent Controller (RIC) 625 via an E2 link, or a Non-Real Time (Non-RT) RIC 615 associated with a Service Management and Orchestration (SMO) Framework 605, or both). A CU 610 may communicate with one or more distributed units (DUs) 630 via respective midhaul links, such as an F1 interface. The DUs 630 may communicate with one or more radio units (RUs) 640 via respective fronthaul links. The RUs 640 may communicate with respective UEs 104 via one or more radio frequency (RF) access links. In some implementations, the UE 104 may be simultaneously served by multiple RUs 640.

Each of the units, e.g., the CUS 610, the DUs 630, the RUs 640, as well as the Near-RT RICs 625, the Non-RT RICs 615 and the SMO Framework 605, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 610 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 610. The CU 610 may be configured to handle user plane functionality (i.e., Central Unit-User Plane (CU-UP)), control plane functionality (i.e., Central Unit-Control Plane (CU-CP)), or a combination thereof. In some implementations, the CU 610 can be logically split into one or more CU-UP units and one or more CU-CP units. The CU-UP unit can communicate bidirectionally with the CU-CP unit via an interface, such as the E1 interface when implemented in an O-RAN configuration. The CU 610 can be implemented to communicate with the DU 630, as necessary, for network control and signaling.

The DU 630 may correspond to a logical unit that includes one or more base station functions to control the operation of one or more RUs 640. In some aspects, the DU 630 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 630 may further host one or more low PHY layers. Each layer (or module) can be implemented with an interface configured to communicate signals with other layers (and modules) hosted by the DU 630, or with the control functions hosted by the CU 610.

Lower-layer functionality can be implemented by one or more RUs 640. In some deployments, an RU 640, controlled by a DU 630, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 640 can be implemented to handle over the air (OTA) communication with one or more UEs 104. In some implementations, real-time and non-real-time aspects of control and user plane communication with the RU(s) 640 can be controlled by the corresponding DU 630. In some scenarios, this configuration can enable the DU(s) 630 and the CU 610 to be implemented in a cloud-based RAN architecture, such as a vRAN architecture.

The SMO Framework 605 may be configured to support RAN deployment and provisioning of non-virtualized and virtualized network elements. For non-virtualized network elements, the SMO Framework 605 may be configured to support the deployment of dedicated physical resources for RAN coverage requirements which may be managed via an operations and maintenance interface (such as an O1 interface). For virtualized network elements, the SMO Framework 605 may be configured to interact with a cloud computing platform (such as an open cloud (O-Cloud) 690) to perform network element life cycle management (such as to instantiate virtualized network elements) via a cloud computing platform interface (such as an O2 interface). Such virtualized network elements can include, but are not limited to, CUs 610, DUs 630, RUs 640 and Near-RT RICs 625. In some implementations, the SMO Framework 605 can communicate with a hardware aspect of a 4G RAN, such as an open eNB (O-eNB) 611, via an O1 interface. Additionally, in some implementations, the SMO Framework 605 can communicate directly with one or more RUs 640 via an O1 interface. The SMO Framework 605 also may include a Non-RT RIC 615 configured to support functionality of the SMO Framework 605.

The Non-RT RIC 615 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 625. The Non-RT RIC 615 may be coupled to or communicate with (such as via an Al interface) the Near-RT RIC 625. The Near-RT RIC 625 may be configured to include a logical function that enables near-real-time control and optimization of RAN elements and resources via data collection and actions over an interface (such as via an E2 interface) connecting one or more CUs 610, one or more DUs 630, or both, as well as an O-eNB, with the Near-RT RIC 625.

In some implementations, to generate AI/ML models to be deployed in the Near-RT RIC 625, the Non-RT RIC 615 may receive parameters or external enrichment information from external servers. Such information may be utilized by the Near-RT RIC 625 and may be received at the SMO Framework 605 or the Non-RT RIC 615 from non-network data sources or from network functions. In some examples, the Non-RT RIC 615 or the Near-RT RIC 625 may be configured to tune RAN behavior or performance. For example, the Non-RT RIC 615 may monitor long-term trends and patterns for performance and employ AI/ML models to perform corrective actions through the SMO Framework 605 (such as reconfiguration via O1) or via creation of RAN management policies (such as A1 policies).

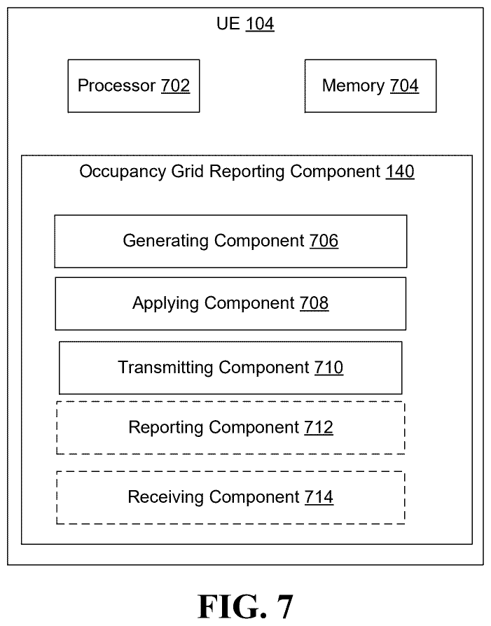

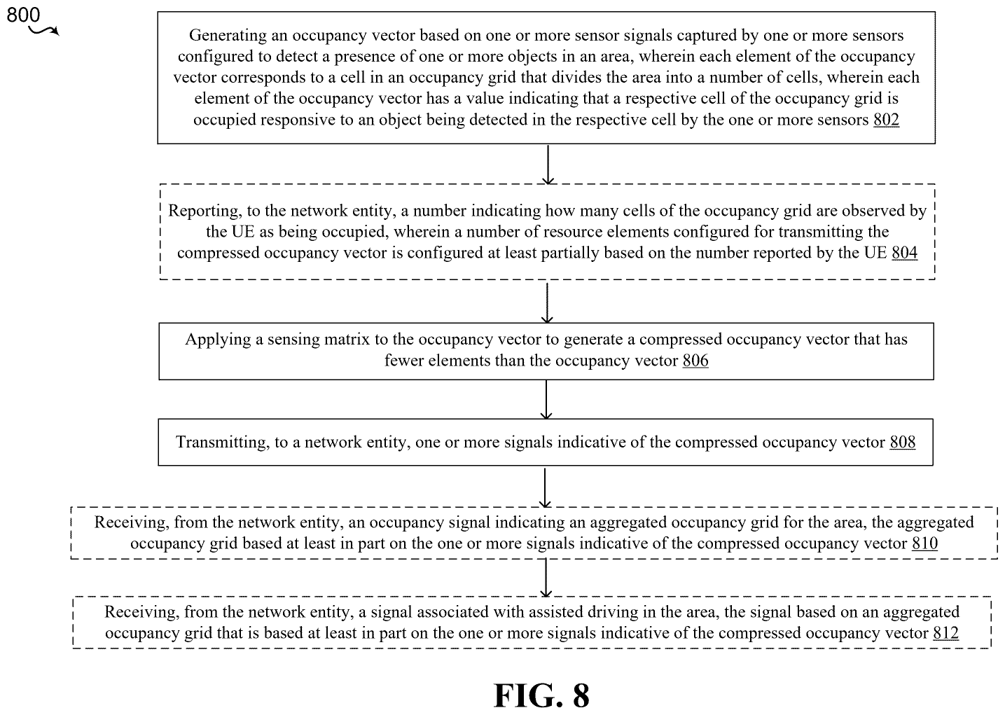

Referring to FIGS. 7 and 8, in operation, the UE 104 may perform a method 800 of wireless communication, by such as via execution of occupancy grid reporting component 140 by processor 702 and/or memory 704. In this and other implementations described herein, the processor 702 may include at least one of the TX processor 568, the RX processor 556, and the controller/processor 559 described above. In the below description of FIG. 8, optional block 804 is described after blocks 806 and 808.

At block 802, the method 800 includes generating an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors. For example, in an aspect, UE 104, processor 702, memory 704, occupancy grid reporting component 140, and/or generating component 706 may be configured to or may comprise means for generating an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors.

For example, referring to FIGS. 3A and 4, in one non-limiting example aspect, the generating at block 802 may include a UE 104 generating an occupancy vector 404 based on one or more sensor signals captured by one or more sensors 308 of the UE 104 that are configured to detect a presence of one or more objects 412 in an area 410, wherein each element of the occupancy vector 404 corresponds to a cell in an occupancy grid 402 that divides the area 410 into a number of cells, wherein each element of the occupancy vector 404 has a value indicating that a respective cell of the occupancy grid 402 is occupied responsive to an object being detected in the respective cell by the one or more sensors 308. For example, the sensor 308 of the UE 104 may detect the object 412 in cells 418 of the occupancy grid 402. Accordingly, for example, in the occupancy vector 404, the two elements that correspond to the occupied cells 418 have a value of 1, and the other elements of the occupancy vector 404 have a value of zero.

At block 806, the method 800 includes applying a sensing matrix to the occupancy vector to generate a compressed occupancy vector that has fewer elements than the occupancy vector. For example, in an aspect, UE 104, processor 702, memory 704, occupancy grid reporting component 140, and/or applying component 708 may be configured to or may comprise means for applying a sensing matrix to the occupancy vector to generate a compressed occupancy vector that has fewer elements than the occupancy vector.

For example, the UE 104 may apply a sensing matrix A to the occupancy vector 404, Xᵢ, to generate a compressed occupancy vector 406, yᵢ, that has fewer elements than the occupancy vector 404, xi.

At block 808, the method 800 includes transmitting, to a network entity, one or more signals indicative of the compressed occupancy vector. For example, in an aspect, UE 104, processor 702, memory 704, occupancy grid reporting component 140, and/or transmitting component 710 may be configured to or may comprise means for transmitting, to a network entity, one or more signals indicative of the compressed occupancy vector.

For example, the UE 104 may transmit, to a network entity 102, one or more signals indicative of the compressed occupancy vector 406.

In some optional implementations, applying the sensing matrix causes a linear transformation of the occupancy vector, wherein the linear transformation is configured to enable determination of the occupancy vector based on the compressed occupancy vector.

In some optional implementations, transmitting the one or more signals comprises transmitting, for an element of the compressed occupancy vector, a signal over a resource element associated with the element of the compressed occupancy vector, wherein an amplitude and phase of the signal are proportional, respectively, to an amplitude and phase of the element of the compressed occupancy vector.

In some optional implementations, each element of the compressed occupancy vector is associated with a unique resource element out of a set of resource elements associated with the compressed occupancy vector.

In some optional implementations, the sensing matrix and the set of resource elements are configured in common for a set of UEs including the UE, wherein an aggregated occupancy vector of the area is determinable based on an aggregation of the one or more signals with one or more other signals transmitted over the set of resource elements by one or more other UEs in the set of UEs, wherein the one or more other signals are indicative of one or more other compressed occupancy vectors generated by the one or more other UEs by applying the sensing matrix to one or more other occupancy vectors of the one or more other UEs.

In some optional implementations, applying the sensing matrix comprises selecting the sensing matrix from a pre-configured plurality of sensing matrices based on the number of cells and a number of resource elements configured for transmitting the compressed occupancy vector.

In some optional implementations, applying the sensing matrix comprises generating the sensing matrix based on the number of cells and a number of resource elements configured for transmitting the compressed occupancy vector.

In some optional implementations, applying the sensing matrix comprises selecting the sensing matrix from a pre-configured plurality of sensing matrices based on a pointer indicated by the network entity.

Optionally, at bock 804, the method 800 includes reporting, to the network entity, a number indicating how many cells of the occupancy grid are observed by the UE as being occupied, wherein a number of resource elements configured for transmitting the compressed occupancy vector is configured at least partially based on the number reported by the UE. For example, in an aspect, UE 104, processor 702, memory 704, occupancy grid reporting component 140, and/or reporting component 712 may be configured to or may comprise means for reporting, to the network entity, a number indicating how many cells of the occupancy grid are observed by the UE as being occupied, wherein a number of resource elements configured for transmitting the compressed occupancy vector is configured at least partially based on the number reported by the UE.

For example, in one non-limiting example aspect, the reporting at block 804 may include the UE 104 reporting, to the network entity 102, a number indicating how many cells of the occupancy grid 402 are observed by the UE 104 as being occupied, wherein a number of resource elements 408 configured for transmitting the compressed occupancy vector 406 is configured at least partially based on the number reported by the UE 104.

In some optional implementations, reporting the number comprises reporting the number periodically and/or responsive to a request by the network entity.

In some optional implementations, transmitting the one or more signals comprises transmitting, for an element of the compressed occupancy vector, a first signal over a first resource element and a second signal over a second resource element, wherein the first resource element and the second resource element are associated with the element of the compressed occupancy vector, wherein a strength of the first signal and the second signal is proportional to a value of the element of the compressed occupancy vector.

In some optional implementations, transmitting the first signal comprises applying a first phase to the first signal, wherein transmitting the second signal comprises applying a second phase to the second signal, wherein the second phase is different than the first phase.

Optionally, at block 810, the method 800 includes receiving, from the network entity, an occupancy signal indicating an aggregated occupancy grid for the area, the aggregated occupancy grid based at least in part on the one or more signals indicative of the compressed occupancy vector. For example, in an aspect, UE 104, processor 702, memory 704, occupancy grid reporting component 140, and/or receiving component 714 may be configured to or may comprise means for receiving, from the network entity, an occupancy signal indicating an aggregated occupancy grid for the area, the aggregated occupancy grid based at least in part on the one or more signals indicative of the compressed occupancy vector.

For example, the UE 104 may receive, from the network entity 102, an occupancy signal indicating an aggregated occupancy grid for the area 410, the aggregated occupancy grid based at least in part on the one or more signals indicative of the compressed occupancy vector 406. For example, the network entity 102 may receive, over the pre-configured REs, an OTA aggregation of multiple signals transmitted by multiple UEs and indicative of respective compressed occupancy vectors of the multiple UEs generated using the common sensing matrix. Having knowledge of the REs and the sensing matrix configured in common for the multiple UEs to generate the respective compressed occupancy vectors, the network entity 102 may recover an aggregated occupancy vector of the area 410 from the received OTA aggregation of the signals of the multiple UEs. The network entity 102 may then transmit an occupancy signal indicating the aggregated occupancy grid for the area 410.

Optionally, at block 812, the method 800 includes receiving, from the network entity, a signal associated with assisted driving in the area, the signal based on an aggregated occupancy grid that is based at least in part on the one or more signals indicative of the compressed occupancy vector. For example, in an aspect, UE 104, processor 702, memory 704, occupancy grid reporting component 140, and/or receiving component 714 may be configured to or may comprise means for receiving, from the network entity, a signal associated with assisted driving in the area, the signal based on an aggregated occupancy grid that is based at least in part on the one or more signals indicative of the compressed occupancy vector.

For example, the UE 104 may receive, from the network entity 102, a signal associated with assisted driving in the area 410, the signal based on an aggregated occupancy grid that is based at least in part on the one or more signals indicative of the compressed occupancy vector 406. For example, the network entity 102 may receive, over the pre-configured REs, an OTA aggregation of multiple signals transmitted by multiple UEs and indicative of respective compressed occupancy vectors of the multiple UEs generated using the common sensing matrix. Having knowledge of the REs and the sensing matrix configured in common for the multiple UEs to generate the respective compressed occupancy vectors, the network entity 102 may recover an aggregated occupancy vector of the area 410 from the received OTA aggregation of the signals of the multiple UEs. The network entity 102 may then transmit a signal associated with assisted driving in the area 410, based on the aggregated occupancy grid of the area 410.

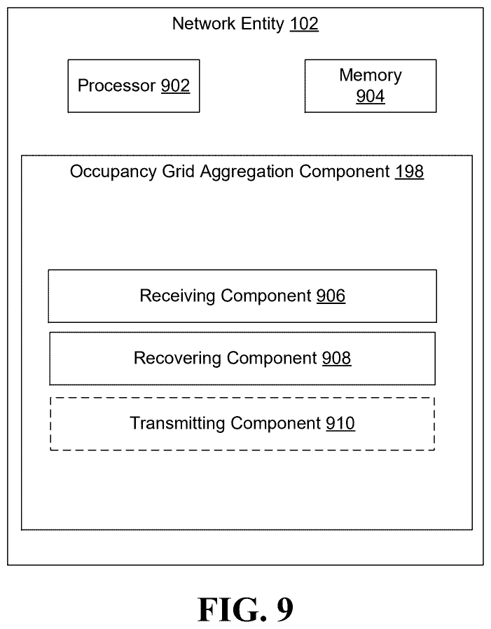

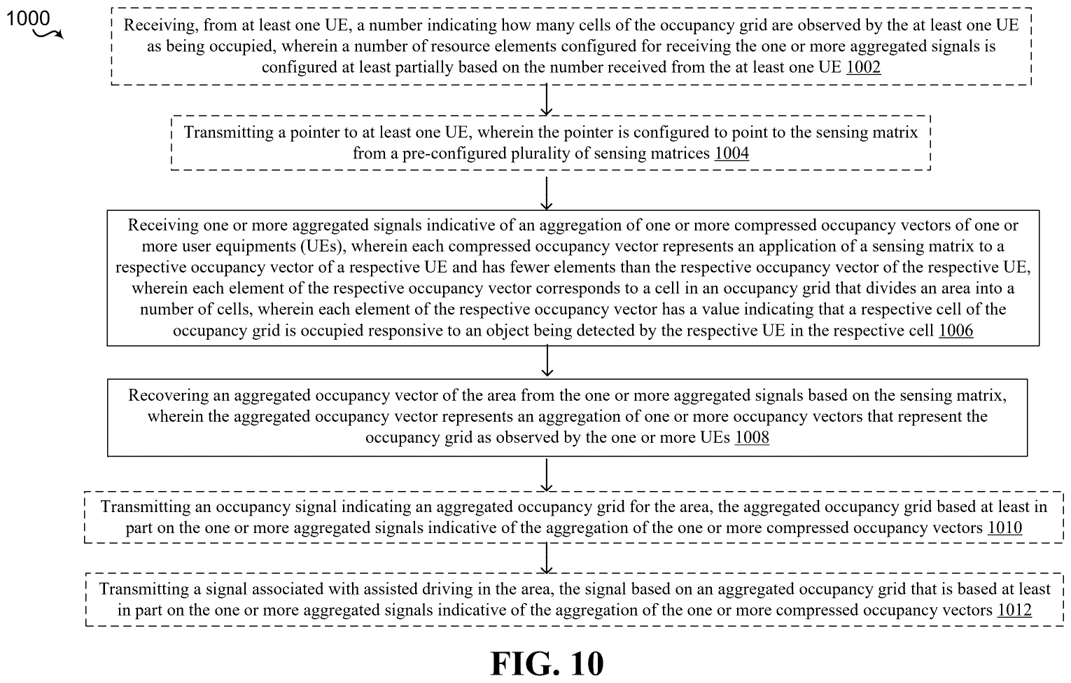

Referring to FIGS. 9 and 10, in operation, the network entity 102 may perform a method 1000 of wireless communication, by such as via execution of occupancy grid aggregation component 198 by processor 902 and/or memory 904. In this and other implementations described herein, the processor 902 may include at least one of the TX processor 516, the RX processor 570, and the controller/processor 575 described above. In the below description of FIG. 10, optional blocks 1002 and 1004 are described after blocks 1006 and 1008.

At block 1006, the method 1000 includes receiving one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell. For example, in an aspect, network entity 102, processor 902, memory 904, occupancy grid aggregation component 198, and/or receiving component 906 may be configured to or may comprise means for receiving one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell.

For example, in one non-limiting example aspect, the receiving at block 1002 may include a network entity 102 receiving one or more aggregated signals indicative of an aggregation of one or more compressed occupancy vectors 406 of one or more UEs 104, wherein each compressed occupancy vector 406 represents an application of a sensing matrix to a respective occupancy vector 404 of a respective UE 104 and has fewer elements than the respective occupancy vector 404 of the respective UE 104, wherein each element of the respective occupancy vector 404 corresponds to a cell in an occupancy grid 402 that divides an area 410 into a number of cells, wherein each element of the respective occupancy vector 404 has a value indicating that a respective cell of the occupancy grid 402 is occupied responsive to an object being detected by the respective UE 104 in the respective cell.

At block 1008, the method 1000 includes recovering an aggregated occupancy vector of the area from the one or more aggregated signals based on the sensing matrix, wherein the aggregated occupancy vector represents an aggregation of one or more occupancy vectors that represent the occupancy grid as observed by the one or more UEs. For example, in an aspect, network entity 102, processor 902, memory 904, occupancy grid aggregation component 198, and/or recovering component 908 may be configured to or may comprise means for recovering an aggregated occupancy vector of the area from the one or more aggregated signals based on the sensing matrix, wherein the aggregated occupancy vector represents an aggregation of one or more occupancy vectors that represent the occupancy grid as observed by the one or more UEs.

For example, the network entity 102 may recover an aggregated occupancy vector of the area 410 from the one or more aggregated signals based on the sensing matrix, wherein the aggregated occupancy vector represents an aggregation of one or more occupancy vectors 404 that represent the occupancy grid 402 as observed by the one or more UEs 104. For example, when an occupancy grid as observed by a UE is sparse (has few non-zero elements), the sensing matrix can be configured in such a way to allow for recovering the occupancy vector of the UE from a compressed occupancy vector of a UE, for example, by using a compressed sensing algorithm such as Orthogonal Matching Pursuit (OMP). Accordingly, having knowledge of the commonly-configured sensing matrix and the commonly-configured REs, the network entity 102 may recover an aggregated occupancy vector of the area 410 from the aggregated signals received over the commonly-configured REs.

In some optional implementations, applying the sensing matrix causes a linear transformation of the respective occupancy vector, wherein the linear transformation is configured to enable determination of the aggregated occupancy vector based on the aggregation of the one or more compressed occupancy vectors.

In some optional implementations, receiving the one or more aggregated signals comprises receiving, for an element of the aggregation of the one or more compressed occupancy vectors, an aggregated signal over a resource element associated with the element of the aggregation of the one or more compressed occupancy vectors.

In some optional implementations, each element of the aggregation of the one or more compressed occupancy vectors is associated with a unique resource element out of a set of resource elements associated with the aggregation of the one or more compressed occupancy vectors.

In some optional implementations, the sensing matrix and the set of resource elements are configured in common for a set of UEs including the one or more UEs, wherein each of the one or more aggregated signals comprises an aggregation of one or more signals transmitted by the one or more UEs over a corresponding resource element.

In some optional implementations, recovering the aggregated occupancy vector comprises selecting the sensing matrix from a pre-configured plurality of sensing matrices based on the number of cells and a number of resource elements configured for receiving the one or more aggregated signals.

In some optional implementations, recovering the aggregated occupancy vector comprises generating the sensing matrix based on the number of cells and a number of resource elements configured for receiving the one or more aggregated signals.

Optionally, at block 1002, the method 1000 includes receiving, from at least one UE, a number indicating how many cells of the occupancy grid are observed by the at least one UE as being occupied, wherein a number of resource elements configured for receiving the one or more aggregated signals is configured at least partially based on the number received from the at least one UE. For example, in an aspect, network entity 102, processor 902, memory 904, occupancy grid aggregation component 198, and/or receiving component 906 may be configured to or may comprise means for receiving, from at least one UE, a number indicating how many cells of the occupancy grid are observed by the at least one UE as being occupied, wherein a number of resource elements configured for receiving the one or more aggregated signals is configured at least partially based on the number received from the at least one UE. For example, the network entity 102 may receive, from at least one UE 104, a number indicating how many cells of the occupancy grid 402 are observed by the at least one UE 104 as being occupied, thus indicating how sparse the occupancy grid 402 is and therefore indicating how short the compressed occupancy vector 406 can be. The number of REs 408 configured for receiving the one or more aggregated signals is then configured at least partially based on the number received from the at least one UE 104.

In some optional implementations, receiving the number comprises receiving the number periodically and/or responsive to sending a request to the at least one UE.

Optionally, at block 1004, the method 1000 includes transmitting a pointer to at least one UE, wherein the pointer is configured to point to the sensing matrix from a pre-configured plurality of sensing matrices. For example, in an aspect, network entity 102, processor 902, memory 904, occupancy grid aggregation component 198, and/or transmitting component 910 may be configured to or may comprise means for transmitting a pointer to at least one UE, wherein the pointer is configured to point to the sensing matrix from a pre-configured plurality of sensing matrices.

For example, in order to configure a UE 104 with a sensing matrix, the network entity 102 may transmit a pointer to the UE 104, wherein the pointer is configured to point to the sensing matrix from a pre-configured plurality of sensing matrices.

In some optional implementations, receiving the one or more aggregated signals comprises receiving, for an element of the aggregation of the one or more compressed occupancy vectors, a first signal over a first resource element and a second signal over a second resource element, wherein the first resource element and the second resource element are associated with the element of the aggregation of the one or more compressed occupancy vectors.

In some optional implementations, recovering the aggregated occupancy vector comprises using one of the first signal and the second signal that has a higher strength. This may improve robustness to phase uncertainties.

Optionally, at block 1010 the method 1000 includes transmitting an occupancy signal indicating an aggregated occupancy grid for the area, the aggregated occupancy grid based at least in part on the one or more aggregated signals indicative of the aggregation of the one or more compressed occupancy vectors. For example, in an aspect, network entity 102, processor 902, memory 904, occupancy grid aggregation component 198, and/or transmitting component 910 may be configured to or may comprise means for transmitting an occupancy signal indicating an aggregated occupancy grid for the area, the aggregated occupancy grid based at least in part on the one or more aggregated signals indicative of the aggregation of the one or more compressed occupancy vectors.

For example, the network entity 102 may transmit an occupancy signal indicating an aggregated occupancy grid for the area 410, the aggregated occupancy grid based at least in part on the one or more aggregated signals indicative of the aggregation of the one or more compressed occupancy vectors 406. For example, the network entity 102 may receive, over the pre-configured REs, an OTA aggregation of multiple signals transmitted by multiple UEs and indicative of respective compressed occupancy vectors of the multiple UEs generated using the common sensing matrix. Having knowledge of the REs and the sensing matrix configured in common for the multiple UEs to generate the respective compressed occupancy vectors, the network entity 102 may recover an aggregated occupancy vector of the area 410 from the received OTA aggregation of the signals of the multiple UEs. The network entity 102 may then transmit an occupancy signal indicating the aggregated occupancy grid for the area 410.

Optionally, at block 1012 the method 1000 includes transmitting a signal associated with assisted driving in the area, the signal based on an aggregated occupancy grid that is based at least in part on the one or more aggregated signals indicative of the aggregation of the one or more compressed occupancy vectors. For example, in an aspect, network entity 102, processor 902, memory 904, occupancy grid aggregation component 198, and/or transmitting component 910 may be configured to or may comprise means for transmitting a signal associated with assisted driving in the area, the signal based on an aggregated occupancy grid that is based at least in part on the one or more aggregated signals indicative of the aggregation of the one or more compressed occupancy vectors.

For example, the network entity 102 may transmit a signal associated with assisted driving in the area 410, the signal based on an aggregated occupancy grid that is based at least in part on the one or more aggregated signals indicative of the aggregation of the one or more compressed occupancy vectors 406. For example, the network entity 102 may receive, over the pre-configured REs, an OTA aggregation of multiple signals transmitted by multiple UEs and indicative of respective compressed occupancy vectors of the multiple UEs generated using the common sensing matrix. Having knowledge of the REs and the sensing matrix configured in common for the multiple UEs to generate the respective compressed occupancy vectors, the network entity 102 may recover an aggregated occupancy vector of the area 410 from the received OTA aggregation of the signals of the multiple UEs. The network entity 102 may then transmit a signal associated with assisted driving in the area 410, based on the aggregated occupancy grid of the area 410.

Some further aspects are provided below.
1. A method of wireless communication by a user equipment (UE), comprising:

generating an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors;
applying a sensing matrix to the occupancy vector to generate a compressed occupancy vector that has fewer elements than the occupancy vector; and
transmitting, to a network entity, one or more signals indicative of the compressed occupancy vector.
2. The method of clause 1, wherein applying the sensing matrix causes a linear transformation of the occupancy vector, wherein the linear transformation is configured to enable determination of the occupancy vector based on the compressed occupancy vector.
3. The method of clause 1 or 2, wherein transmitting the one or more signals comprises transmitting, for an element of the compressed occupancy vector, a signal over a resource element associated with the element of the compressed occupancy vector, wherein an amplitude and phase of the signal are proportional, respectively, to an amplitude and phase of the element of the compressed occupancy vector.
4. The method of clause 3, wherein each element of the compressed occupancy vector is associated with a unique resource element out of a set of resource elements associated with the compressed occupancy vector.
5. The method of clause 4, wherein the sensing matrix and the set of resource elements are configured in common for a set of UEs including the UE, wherein an aggregated occupancy vector of the area is determinable based on an aggregation of the one or more signals with one or more other signals transmitted over the set of resource elements by one or more other UEs in the set of UEs, wherein the one or more other signals are indicative of one or more other compressed occupancy vectors generated by the one or more other UEs by applying the sensing matrix to one or more other occupancy vectors of the one or more other UEs.
6. The method of any one of clauses 1 to 5, wherein applying the sensing matrix comprises selecting the sensing matrix from a pre-configured plurality of sensing matrices based on the number of cells and a number of resource elements configured for transmitting the compressed occupancy vector.
7. The method of any one of clauses 1 to 5, wherein applying the sensing matrix comprises generating the sensing matrix based on the number of cells and a number of resource elements configured for transmitting the compressed occupancy vector.
8. The method of any one of clauses 1 to 5, wherein applying the sensing matrix comprises selecting the sensing matrix from a pre-configured plurality of sensing matrices based on a pointer indicated by the network entity.
9. The method of any one of the above clauses, further comprising reporting, to the network entity, a number indicating how many cells of the occupancy grid are observed by the UE as being occupied, wherein a number of resource elements configured for transmitting the compressed occupancy vector is configured at least partially based on the number reported by the UE.
10. The method of clause 9, wherein reporting the number comprises reporting the number periodically and/or responsive to a request by the network entity.
11. The method of any one of the above clauses, wherein transmitting the one or more signals comprises transmitting, for an element of the compressed occupancy vector, a first signal over a first resource element and a second signal over a second resource element, wherein the first resource element and the second resource element are associated with the element of the compressed occupancy vector, wherein a strength of the first signal and the second signal is proportional to a value of the element of the compressed occupancy vector.
12. The method of clause 11, wherein transmitting the first signal comprises applying a first phase to the first signal, wherein transmitting the second signal comprises applying a second phase to the second signal, wherein the second phase is different than the first phase.
13. The method of any one of the above clauses, further comprising receiving, from the network entity, an occupancy signal indicating an aggregated occupancy grid for the area, the aggregated occupancy grid based at least in part on the one or more signals indicative of the compressed occupancy vector.
14. The method of any one of the above clauses, further comprising receiving, from the network entity, a signal associated with assisted driving in the area, the signal based on an aggregated occupancy grid that is based at least in part on the one or more signals indicative of the compressed occupancy vector.
15. A user equipment (UE), comprising:
a memory storing instructions; and
a processor communicatively coupled with the memory, wherein the processor is configured to execute the instructions to:
generate an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors;
apply a sensing matrix to the occupancy vector to generate a compressed occupancy vector that has fewer elements than the occupancy vector; and
transmit, to a network entity, one or more signals indicative of the compressed occupancy vector.
15-1. The UE of clause 15, wherein the processor is further configured to execute the instructions to perform the method of any one of clauses 2 to 14.
15-2. An apparatus comprising means for performing the method of any one of clauses 1 to 14.
15-3. A computer-readable medium storing instructions that, when executed by a processor, cause the processor to perform the method of any one of clauses 1 to 14.
16. A method of wireless communication by a network entity, comprising:
receiving one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell; and recovering an aggregated occupancy vector of the area from the one or more aggregated signals based on the sensing matrix, wherein the aggregated occupancy vector represents an aggregation of one or more occupancy vectors that represent the occupancy grid as observed by the one or more UEs.
17. The method of clause 16, wherein applying the sensing matrix causes a linear transformation of the respective occupancy vector, wherein the linear transformation is configured to enable determination of the aggregated occupancy vector based on the aggregation of the one or more compressed occupancy vectors.
18. The method of clause 16 or 17, wherein receiving the one or more aggregated signals comprises receiving, for an element of the aggregation of the one or more compressed occupancy vectors, an aggregated signal over a resource element associated with the element of the aggregation of the one or more compressed occupancy vectors.
19. The method of clause 18, wherein each element of the aggregation of the one or more compressed occupancy vectors is associated with a unique resource element out of a set of resource elements associated with the aggregation of the one or more compressed occupancy vectors.
20. The method of clause 19, wherein the sensing matrix and the set of resource elements are configured in common for a set of UEs including the one or more UEs, wherein each of the one or more aggregated signals comprises an aggregation of one or more signals transmitted by the one or more UEs over a corresponding resource element.
21. The method of any one of clauses 16 to 20, wherein recovering the aggregated occupancy vector comprises selecting the sensing matrix from a pre-configured plurality of sensing matrices based on the number of cells and a number of resource elements configured for receiving the one or more aggregated signals.
22. The method of any one of clauses 16 to 20, wherein recovering the aggregated occupancy vector comprises generating the sensing matrix based on the number of cells and a number of resource elements configured for receiving the one or more aggregated signals.
23. The method of any one of clauses 16 to 20, further comprising transmitting a pointer to at least one UE, wherein the pointer is configured to point to the sensing matrix from a pre-configured plurality of sensing matrices.
24. The method of any one of clauses 16 to 23, further comprising receiving, from at least one UE, a number indicating how many cells of the occupancy grid are observed by the at least one UE as being occupied, wherein a number of resource elements configured for receiving the one or more aggregated signals is configured at least partially based on the number received from the at least one UE.
25. The method of clause 24, wherein receiving the number comprises receiving the number periodically and/or responsive to sending a request to the at least one UE.
26. The method of any one of clauses 16 to 25, wherein receiving the one or more aggregated signals comprises receiving, for an element of the aggregation of the one or more compressed occupancy vectors, a first signal over a first resource element and a second signal over a second resource element, wherein the first resource element and the second resource element are associated with the element of the aggregation of the one or more compressed occupancy vectors.
27. The method of clause 26, wherein recovering the aggregated occupancy vector comprises using one of the first signal and the second signal that has a higher strength.
28. The method of any one of clauses 16 to 27, further comprising transmitting an occupancy signal indicating an aggregated occupancy grid for the area, the aggregated occupancy grid based at least in part on the one or more aggregated signals indicative of the aggregation of the one or more compressed occupancy vectors.
29. The method of any one of clauses 16 to 28, further comprising transmitting a signal associated with assisted driving in the area, the signal based on an aggregated occupancy grid that is based at least in part on the one or more aggregated signals indicative of the aggregation of the one or more compressed occupancy vectors.
30. A network entity, comprising:
a memory storing instructions; and
a processor communicatively coupled with the memory, wherein the processor is configured to execute the instructions to:
receive one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell; and
recover an aggregated occupancy vector of the area from the one or more aggregated signals based on the sensing matrix, wherein the aggregated occupancy vector represents an aggregation of one or more occupancy vectors that represent the occupancy grid as observed by the one or more UEs.
30-1. The network entity of clause 30, wherein the processor is further configured to execute the instructions to perform the method of any one of clauses 17 to 29.
30-2. An apparatus comprising means for performing the method of any one of clauses 16 to 29.
30-3. A computer-readable medium storing instructions that, when executed by a processor, cause the processor to perform the method of any one of clauses 16 to 29.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication by a user equipment (UE), comprising:
generating an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors;
applying a sensing matrix to the occupancy vector to generate a compressed occupancy vector that has fewer elements than the occupancy vector; and
transmitting, to a network entity, one or more signals indicative of the compressed occupancy vector.

2. The method of claim 1, wherein applying the sensing matrix causes a linear transformation of the occupancy vector, wherein the linear transformation is configured to enable determination of the occupancy vector based on the compressed occupancy vector.

3. The method of claim 1, wherein transmitting the one or more signals comprises transmitting, for an element of the compressed occupancy vector, a signal over a resource element associated with the element of the compressed occupancy vector, wherein an amplitude and phase of the signal are proportional, respectively, to an amplitude and phase of the element of the compressed occupancy vector.

4. The method of claim 3, wherein each element of the compressed occupancy vector is associated with a unique resource element out of a set of resource elements associated with the compressed occupancy vector.

5. The method of claim 4, wherein the sensing matrix and the set of resource elements are configured in common for a set of UEs including the UE, wherein an aggregated occupancy vector of the area is determinable based on an aggregation of the one or more signals with one or more other signals transmitted over the set of resource elements by one or more other UEs in the set of UEs, wherein the one or more other signals are indicative of one or more other compressed occupancy vectors generated by the one or more other UEs by applying the sensing matrix to one or more other occupancy vectors of the one or more other UEs.

6. The method of claim 1, wherein applying the sensing matrix comprises selecting the sensing matrix from a pre-configured plurality of sensing matrices based on the number of cells and a number of resource elements configured for transmitting the compressed occupancy vector.

7. The method of claim 1, wherein applying the sensing matrix comprises generating the sensing matrix based on the number of cells and a number of resource elements configured for transmitting the compressed occupancy vector.

8. The method of claim 1, wherein applying the sensing matrix comprises selecting the sensing matrix from a pre-configured plurality of sensing matrices based on a pointer indicated by the network entity.

9. The method of claim 1, further comprising reporting, to the network entity, a number indicating how many cells of the occupancy grid are observed by the UE as being occupied, wherein a number of resource elements configured for transmitting the compressed occupancy vector is configured at least partially based on the number reported by the UE.

10. The method of claim 9, wherein reporting the number comprises reporting the number periodically and/or responsive to a request by the network entity.

11. The method of claim 1, wherein transmitting the one or more signals comprises transmitting, for an element of the compressed occupancy vector, a first signal over a first resource element and a second signal over a second resource element, wherein the first resource element and the second resource element are associated with the element of the compressed occupancy vector, wherein a strength of the first signal and the second signal is proportional to a value of the element of the compressed occupancy vector.

12. The method of claim 11, wherein transmitting the first signal comprises applying a first phase to the first signal, wherein transmitting the second signal comprises applying a second phase to the second signal, wherein the second phase is different than the first phase.

13. The method of claim 1, further comprising receiving, from the network entity, an occupancy signal indicating an aggregated occupancy grid for the area, the aggregated occupancy grid based at least in part on the one or more signals indicative of the compressed occupancy vector.

14. The method of claim 1, further comprising receiving, from the network entity, a signal associated with assisted driving in the area, the signal based on an aggregated occupancy grid that is based at least in part on the one or more signals indicative of the compressed occupancy vector.

15. A user equipment (UE), comprising:
a memory storing instructions; and
a processor communicatively coupled with the memory, wherein the processor is configured to execute the instructions to:
generate an occupancy vector based on one or more sensor signals captured by one or more sensors configured to detect a presence of one or more objects in an area, wherein each element of the occupancy vector corresponds to a cell in an occupancy grid that divides the area into a number of cells, wherein each element of the occupancy vector has a value indicating that a respective cell of the occupancy grid is occupied responsive to an object being detected in the respective cell by the one or more sensors;
apply a sensing matrix to the occupancy vector to generate a compressed occupancy vector that has fewer elements than the occupancy vector; and
transmit, to a network entity, one or more signals indicative of the compressed occupancy vector.

16. A method of wireless communication by a network entity, comprising:
receiving one or more aggregated signals indicative of an aggregation of one or more compressed occupancy vectors of one or more user equipments (UEs), wherein each compressed occupancy vector represents an application of a sensing matrix to a respective occupancy vector of a respective UE and has fewer elements than the respective occupancy vector of the respective UE, wherein each element of the respective occupancy vector corresponds to a cell in an occupancy grid that divides an area into a number of cells, wherein each element of the respective occupancy vector has a value indicating that a respective cell of the occupancy grid is occupied responsive to an object being detected by the respective UE in the respective cell; and
recovering an aggregated occupancy vector of the area from the one or more aggregated signals based on the sensing matrix, wherein the aggregated occupancy vector represents an aggregation of one or more occupancy vectors that represent the occupancy grid as observed by the one or more UEs.

17. The method of claim 16, wherein applying the sensing matrix causes a linear transformation of the respective occupancy vector, wherein the linear transformation is configured to enable determination of the aggregated occupancy vector based on the aggregation of the one or more compressed occupancy vectors.

18. The method of claim 16, wherein receiving the one or more aggregated signals comprises receiving, for an element of the aggregation of the one or more compressed occupancy vectors, an aggregated signal over a resource element associated with the element of the aggregation of the one or more compressed occupancy vectors.

19. The method of claim 18, wherein each element of the aggregation of the one or more compressed occupancy vectors is associated with a unique resource element out of a set of resource elements associated with the aggregation of the one or more compressed occupancy vectors.

20. The method of claim 19, wherein the sensing matrix and the set of resource elements are configured in common for a set of UEs including the one or more UEs, wherein each of the one or more aggregated signals comprises an aggregation of one or more signals transmitted by the one or more UEs over a corresponding resource element.

21-30. (canceled)
